(19) United States
(12) Patent Application Publication
(10) Pub. No.: US 2021/0274710 A1
(43) Pub. Date: Sep. 9, 2021

(54) VARIABLE SPEED REEL DRIVE FOR A HEADER OF AN AGRICULTURAL HARVESTER

(71) Applicant: CNH Industrial America LLC, New Holland, PA (US)

(72) Inventors: Stephen Todderud, Lancaster, PA (US); Kevin Ward, Lititz, PA (US); Preston L. McKinney, Rebersburg, PA (US); Herbert M. Farley, Elizabethtown, PA (US); Scott Palmer Deichmann, Phoenixville, PA (US); Joel T. Cook, Akron, PA (US)

(73) Assignee: CNH Industrial America LLC, New Holland, PA (US)

(21) Appl. No.: 16/810,374

(22) Filed: Mar. 5, 2020

(51) Int. Cl. A01D 41/127; A01D 57/02; A01D 41/14; F16H 3/66

(52) U.S. Cl. CPC A01D 41/1274; F16H 3/66; A01D 41/142; A01D 57/02

(57) ABSTRACT

An agricultural harvester header including a first reel, a second reel adjacent the first reel, and a variable speed reel drive between the first and second reels and operatively connected to at least one of the first reel for rotatably driving the first reel and the second reel for rotatably driving the second reel. The variable speed reel drive can include: a variable speed motor, and a multi-speed gearbox operatively coupled to the variable speed motor and at least one of the reels; a motor, and a continuously variable transmission operatively connected to the motor and at least one of the reels; or a motor, and a planetary gear drive operatively coupled to the motor and at least one of the reels.

The exemplary embodiments of present invention relate generally to a header of a plant cutting machine (e.g., a combine harvester) and, more specifically, to a header having a variable speed reel drive located between and driving at least one of adjacent first and second reels.

### BACKGROUND OF THE INVENTION

An agricultural harvester e.g., a plant cutting machine, such as, but not limited to, a combine or a windrower, generally includes a header operable for severing and collecting plant or crop material as the harvester is driven over a crop field. The header has a plant cutting mechanism, e.g., a cutter bar, for severing the plants or crops via, for example, an elongate sickle mechanism that reciprocates sidewardly relative to a non-reciprocating guard structure. The header further includes at least one driven reel for directing upstanding crops towards the plant cutting mechanism. After crops are cut, they are collected inside the header and transported via a conveyor such as a draper belt towards a feederhouse located centrally inside the header.

Conventional agricultural harvester headers often include two or more adjacent reels that are driven at one outer lateral end by a hydraulic or electric motor coupled to a gearbox or other driving mechanism that is drivingly connected to the reels. A joint is located between adjacent reels so that the rotational velocity of the reels may be reduced or increased in unison as may be dictated by crop conditions. A disadvantage with providing of motors and driving mechanisms at the ends of the reels is that they add to the overall header width without increasing the effective cutting width of the header. Additionally, a conventional hydraulic motor cannot accommodate both low-speed, high-torque and high-speed, low torque operations very well.

### SUMMARY OF THE INVENTION

In accordance with an exemplary embodiment there is provided an agricultural harvester header comprising a first reel and a second reel adjacent the first reel. The header further includes a variable speed reel drive between the first and second reels and operatively connected to at least one of the first reel for rotatably driving the first reel and the second reel for rotatably driving the second reel.

An aspect of the exemplary embodiment is that the variable speed reel drive includes a variable speed motor, and a multi-speed gearbox operatively coupled to the variable speed motor and at least one of the first and second reels. Another aspect of the exemplary embodiment is that the variable speed reel drive includes a motor, and a continuously variable transmission operatively connected to the motor and at least one of the first reel for rotatably driving the first reel and second reel for rotatably driving the second reel. Another aspect of the exemplary embodiment is that the variable speed reel drive includes a motor, and a planetary gear drive operatively coupled to the motor and at least one of the first and second reels.

In accordance with the present disclosure, there is provided an agricultural harvester header having a variable speed reel drive located between and driving at least one of adjacent first and second reels. Such a construction enables control of the motors so that the rotational velocity of the reels may be synchronously reduced or increased as may be dictated by crop conditions. In addition, provision of motors and driving mechanisms between the reels does not increase the overall header width while maintaining the effective cutting width of the header. Another advantage of a variable speed reel drive is that it can readily accommodate both low-speed, high-torque and high-speed, low torque operations. In addition, the variable speed reel drives according to the subject disclosure enable changes in mechanical ratio along with changes in hydraulic ratio.

Other features and advantages of the subject disclosure will be apparent from the following more detailed description of the exemplary embodiments.

### BRIEF DESCRIPTION OF THE DRAWINGS

The foregoing summary, as well as the following detailed description of the exemplary embodiments of the subject disclosure, will be better understood when read in conjunction with the appended drawings. For the purpose of illustrating the present disclosure, there are shown in the drawings exemplary embodiments. It should be understood, however, that the subject application is not limited to the precise arrangements and instrumentalities shown.

FIG. 1 is a front elevation view of an agricultural harvester including a header in accordance with an exemplary embodiment of the subject disclosure;

FIG. 2 is an enlarged partial top plan view of a variable speed reel drive in accordance with an exemplary embodiment of the subject disclosure suitable for use with the header of FIG. 1;

FIG. 3 is an enlarged perspective view of a portion of the variable speed reel drive of FIG. 2 with certain elements omitted for purposes of illustration;

FIG. 4 is an enlarged partial top plan view of a variable speed reel drive in accordance with a further exemplary embodiment of the subject disclosure suitable for use with the header of FIG. 1;

FIG. 5 is an enlarged perspective view of a portion of the variable speed reel drive of FIG. 4 with certain elements omitted for purposes of illustration;

FIG. 6 is a perspective view of a portion of the variable speed reel drive of FIG. 4;

FIG. 7 is an enlarged partial rear view of a variable speed reel drive in accordance with a further exemplary embodiment of the subject disclosure suitable for use with the header of FIG. 1;

FIG. 8 is an enlarged perspective of a portion of the variable speed reel drive of FIG. 7 with certain elements omitted for purposes of illustration; and

FIG. 9 is an enlarged perspective view of the variable speed reel drive of FIG. 7.

### DETAILED DESCRIPTION OF THE DRAWINGS

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject application in any manner not explicitly set forth. Additionally, the term “a,” as used in the specification, means “at least one.” The terminology includes the words above specifically mentioned, derivatives thereof, and words of similar import.

The terms “grain,” “ear,” “stalk,” “leaf,” and “crop material” are used throughout the specification for convenience and it should be understood that these terms are not intended to be limiting. Thus, “grain” refers to that part of a crop which is harvested and separated from discardable portions of the crop material. The header of the subject application is applicable to a variety of crops, including but not limited to wheat, soybeans and small grains. The terms “debris,” “material other than grain,” and the like are used interchangeably.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art.

Throughout the subject application, various aspects thereof can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the subject disclosure can be practiced without one or more of the specific features or advantages of a particular exemplary embodiment. In other instances, additional features and advantages may be recognized in certain embodiments that may not be present in all exemplary embodiments of the present disclosure.

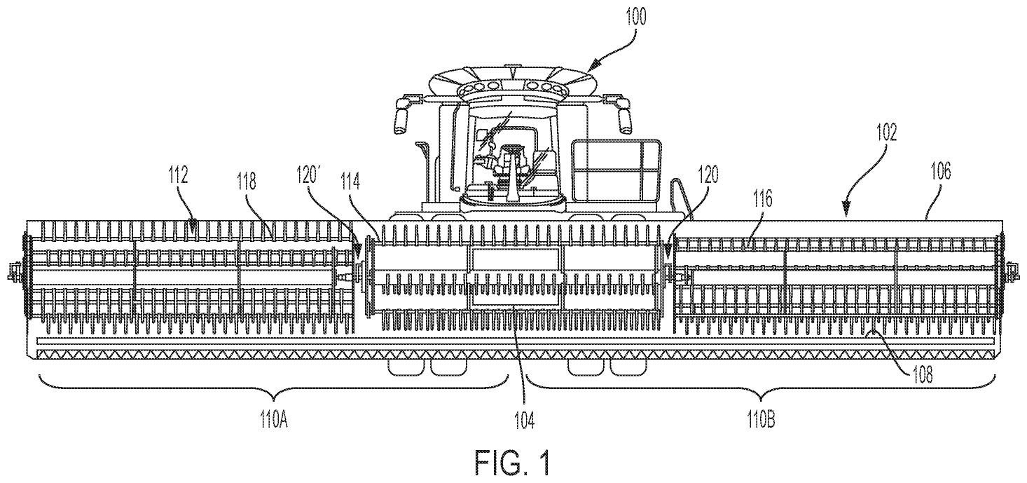

Referring now to the drawings, FIG. 1 illustrates an agricultural harvester 100 in accordance with an exemplary embodiment of the present disclosure. For exemplary purposes only, the agricultural harvester is illustrated as a combine harvester. The harvester 100 includes a header 102 attached to a forward end of the harvester 100, which is configured to cut crops, including (without limitation) small grains (e.g., wheat, soybeans, grain, etc.), and to induct the cut crops into a feederhouse 104 as the harvester moves forward over a crop field.

The header 102 includes a frame 106 having a floor 108 that is supported in desired proximity to the surface of a crop field. First and second cutting assemblies 110A, 110E extend transversely along a forward edge of the floor 108 i.e., in a widthwise direction of the harvester. The first and second cutting assemblies 110A, 110B, are configured to cut crops in preparation for induction into the feederhouse 104. Exemplary cutting assemblies applicable to the present exemplary embodiments are disclosed in U.S. Pat. Nos. 7,730,709 and 8,151,547, the entire disclosures of which are incorporated by reference herein in their entirety for all purposes.

The header may include one or more draper conveyor belts for conveying cut crops to the feederhouse 104, which is configured to convey the cut crops into the harvester 100 for threshing and cleaning as the harvester moves forward over a crop field. The header 102 further includes an elongated, multi-segment rotatable reel 112 which extends above and in close proximity to the first and second cutting assemblies 110A, 110B. The rotatable reel 112 is configured to cooperate with the one or more draper conveyors in conveying cut crops to the feeder house 104 for threshing and cleaning. While the foregoing aspects of the harvester are being described with respect to the header shown, the cutting assembly of the subject application can be applied to any other header having use for such a cutting assembly.

The multi-segment rotatable reel 112 comprises a first reel 114, a second reel 116 adjacent the first reel and, optionally, a third reel 118 adjacent the first reel opposite the second reel. The header further comprises a variable speed reel drive 120 between the first and second reels 114, 116 and operatively connected to at least one of the first reel for rotatably driving the first reel and the second reel for rotatably driving the second reel. In lieu of the variable speed reel drive 120 between the first and second reels 114, 116, the header may include a variable speed reel drive 120′ between the first and third reels 114, 118 and operatively connected to at least one of the first reel for rotatably driving the first reel and the third reel for rotatably driving the third reel. In the event the header is equipped with the variable speed reel drive 120, the third reel 118 is configured to be directly driven by the first reel 114. Conversely, in the event the header is equipped with the variable speed drive 120′, the second reel 116 is configured to be directly driven by the first reel 114.

According to an aspect, the variable speed reel drive 120 can be operatively connected to the first and second reels 114, 116 for rotatably driving the first and second reels. Likewise, the variable speed reel drive 120′ can be operatively connected to the first and third reels 114, 118 for rotatably driving the first and third reels.

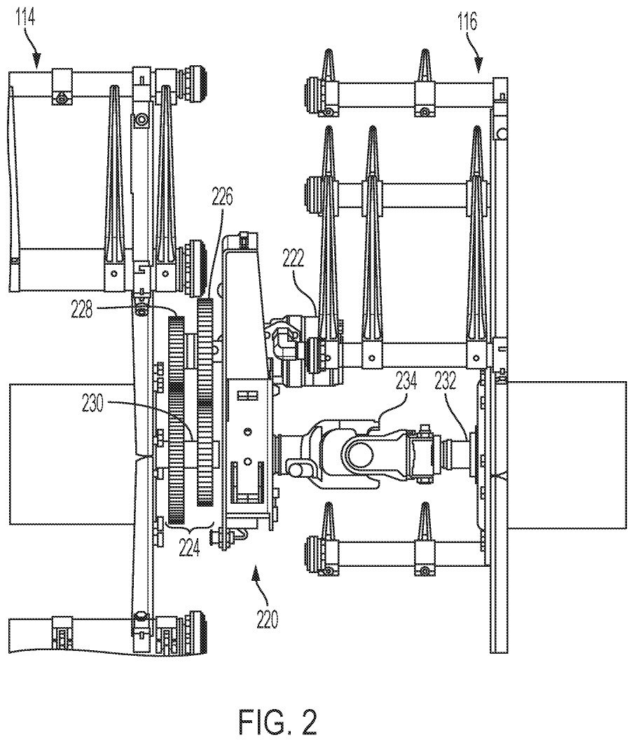

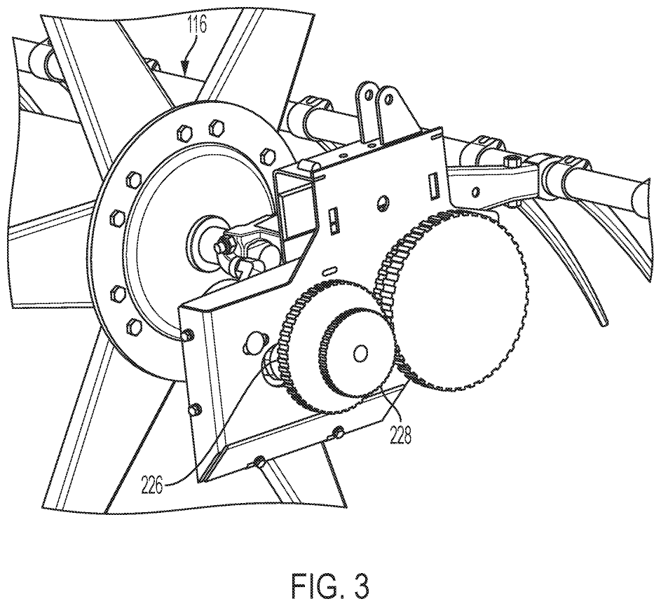

Referring to FIGS. 2 and 3, there is shown a variable speed reel drive 220 in accordance with an exemplary embodiment of the subject disclosure operatively connected to the first and second reels 114, 116. More particularly, the variable speed reel drive 220 comprises a variable speed motor 222 and a multi-speed gearbox 224 operatively coupled to the variable speed motor and at least one of the first and second reels. The variable speed motor may be a suitable hydraulic, electric or mechanical motor capable of operating at various output speeds. According to an aspect, the multi-speed gearbox 224 can be operatively coupled to the first and second reels 114, 116 for rotatably driving the first and second reels.

The multi-speed gearbox 224 comprises a first gear 226 having a first drive ratio. Additionally, the multi-speed gearbox 224 comprises a second gear 228 having a second drive ratio that differs from the first drive ratio for driving at least one of the first and second reels. Exemplary drive ratios for the first gear 226 can be e.g. 3.1:1, but can be higher or lower such as 2.8:1, 2.9:1, 3.0:1, 3.2:1, 3.3:1, 3.4:1, and exemplary drive ratios for the second gear 228 can be e.g. 4.2:1, but can be higher or lower such as 3.9:1, 4.0:1, 4.1:1, 4.3:1, 4.4:1, 4.5:1.

The first reel 114 includes a first reel drive shaft 230 for rotating the first reel, and the second reel 116 includes a second reel drive shaft 232 for rotating the second reel. The first reel drive shaft 230 is coupled to the second reel drive shaft via a universal joint 234 or other suitable connection.

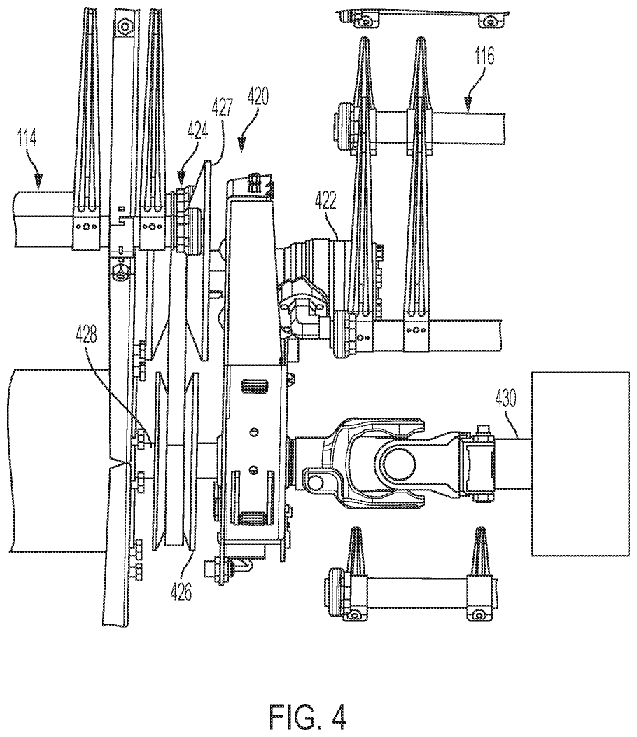

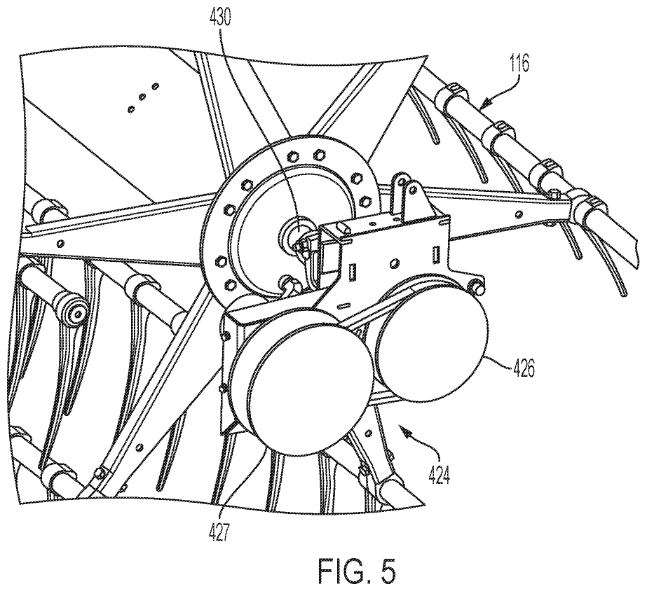

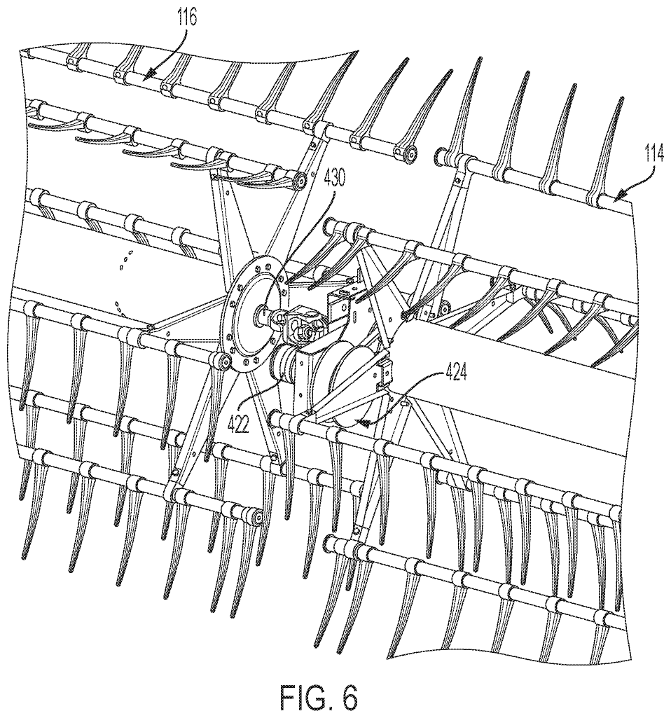

Referring to FIGS. 4-6, there is shown a variable speed reel drive 420 in accordance with another exemplary embodiment of the subject disclosure operatively connected to the first and second reels 114, 116. More particularly, the variable speed reel drive 420 comprises a motor 422 and a continuously variable transmission 424 operatively coupled to the motor and at least one of the first reel for rotatably driving the first reel and the second reel for rotatably driving the second reel. According to an aspect, the continuously variable transmission 424 is operatively connected to the first and second reels for driving the first and second reels. The motor may be a suitable hydraulic, electric or mechanical motor.

The continuously variable transmission 424 includes a first sheave 426 that can be mounted to one of a first reel drive shaft 428 of the first reel 114 and a second reel drive shaft 430 of the second reel 116, and a second sheave 427. As shown in FIG. 4, the sheave 426 is mounted to the first reel drive shaft 428. The second sheave 427 is rotatably driven by the motor. The exemplary embodiment shown in FIG. 4 is a variable-diameter pulley continuously variable transmission. Alternatively, the continuously variable transmission 424 can be a push-belt continuously variable transmission, a planetary continuously variable transmission, hydrostatic continuously variable transmission, or an infinitely variable transmission. U.S. Pat. No. 6,086,499 discloses a push-belt continuously variable transmission applicable to the present embodiment. U.S. Pat. No. 7,214,159 discloses a planetary continuously variable transmission applicable to the present embodiment. U.S. Pat. No. 7,941,998 discloses a hydrostatic continuously variable transmission applicable to the present embodiment. And, U.S. Pat. No. 4,854,919 discloses an infinitely variable transmission applicable to the present embodiment.

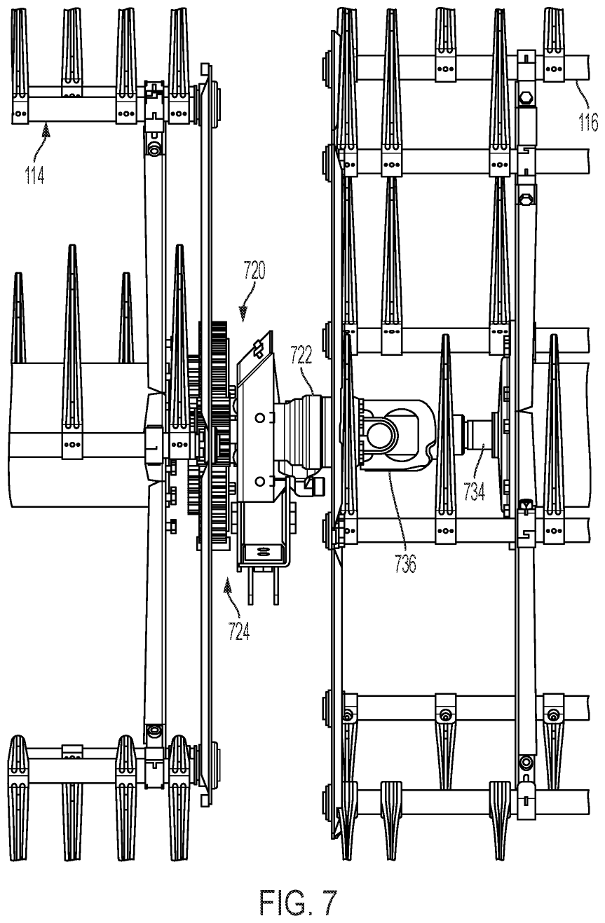

Referring to FIGS. 7 through 9, there is shown a variable speed reel drive 720 in accordance with another exemplary embodiment of the subject disclosure operatively connected to the first and second reels 114, 116. More particularly, the variable speed reel drive 720 comprises a motor 722, and a planetary gear drive 724 operatively coupled to the motor and at least one of the first and second reels. The motor may be a suitable hydraulic, electric or mechanical motor. According to an aspect, the planetary gear drive is 724 is operatively coupled to the first and second reels. Specifically, the planetary gear drive 724 is connected to the reel drive shaft of the first reel and operatively connected to the reel drive shaft of the second reel via a universal joint 736.

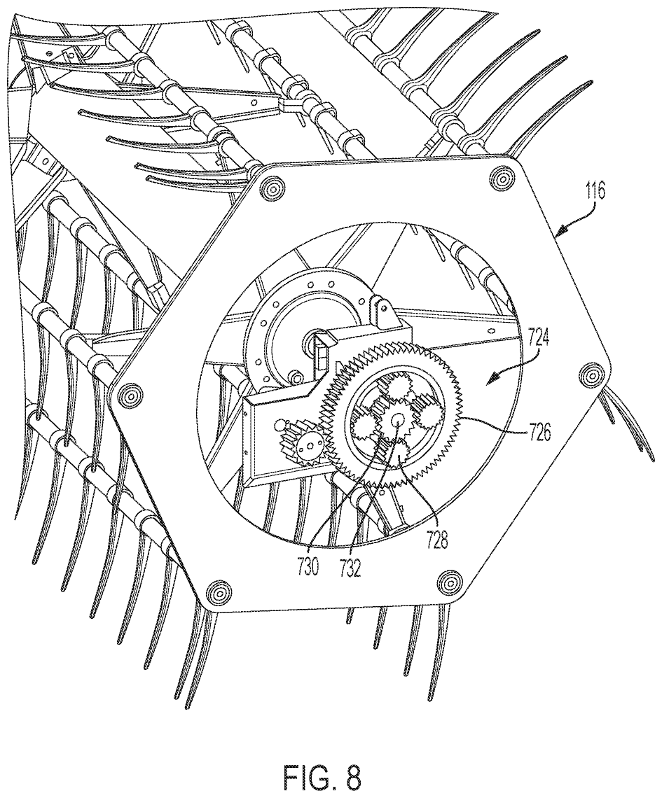

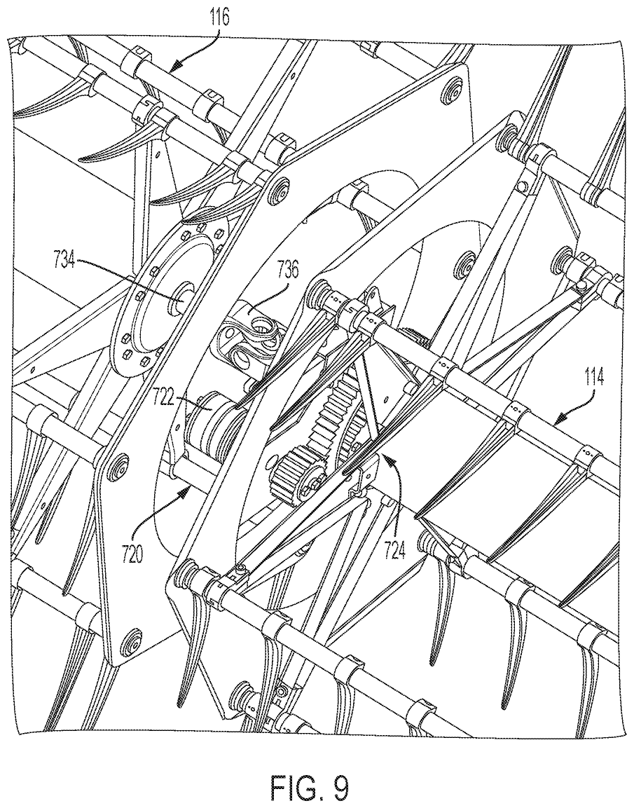

As most clearly shown in FIG. 8, the planetary gear drive is 724 comprises a ring gear 726, at least one planetary gear 728 within the ring gear, and a sun gear 730 within the ring gear. The sun gear 730 is operatively coupled to the first and second reels 114, 116. According to an aspect, the sun gear is affixed to at least one of a first reel drive shaft 732 of the first reel for rotating the first reel and a second reel drive shaft 734 of the second reel for rotating the second reel (FIGS. 7 and 9). In the present embodiment shown in FIG. 8, the sun gear 730 is connected to the reel drive shaft 732 of the first reel.

An advantage of the planetary gear arrangement is that the carrier can be locked to the sun gear or the ring gear and different ratios can be obtained. In general, by locking the carrier to the ring gear, the sun gear or at least one planetary gear, three speed ratios can be obtained in a physically compact assembly.

An advantage of the exemplary embodiments of the variable speed reel drives according to the subject disclosure is that it allows more control of the motor speed and/or the various drives so that the rotational velocity of adjacent reels may be reduced or increased in unison as may be dictated by crop conditions. This advantage allows higher torque or higher speed or lower torque or lower speed when needed. In addition, by providing motors and drives between adjacent reels, the effective cutting width of the header can be maintained without increasing the overall header width. Consequently, the header cuts crop for essentially its entire width without having uncut crop at the opposite ends of the header, as often occurs when reel drives are located at the outer ends of the reels of a multi-segment reel.

It will be appreciated by those skilled in the art that changes could be made to the exemplary embodiments described above without departing from the broad inventive concept thereof. It is to be understood, therefore, that this disclosure is not limited to the particular embodiments disclosed, but it is intended to cover modifications within the spirit and scope of the subject disclosure as defined by the appended claims.

I/we claim:

1. An agricultural harvester header comprising:
a first reel;
a second reel adjacent the first reel; and
a variable speed reel drive between the first and second reels and operatively connected to at least one of the first reel for rotatably driving the first reel and the second reel for rotatably driving the second reel.

2. The agricultural harvester header of claim 1, wherein the variable speed reel drive is operatively connected to the first and second reels for rotatably driving the first and second reels.

3. The agricultural harvester header of claim 1, wherein the variable speed reel drive comprises:
a variable speed motor; and
a multi-speed gearbox operatively coupled to the variable speed motor and at least one of the first and second reels.

4. The agricultural harvester header of claim 3, wherein the multi-speed gearbox is operatively connected to the first and second reels for rotatably driving the first and second reels.

5. The agricultural harvester header of claim 3, wherein the multi-speed gearbox comprises:
a first gear having a first drive ratio for driving at least one of the first and second reels, and
a second gear having a second drive ratio that differs from the first drive ratio for driving the at least one of the first and second reels.

6. The agricultural harvester header of claim 3, wherein the first reel includes a first reel drive shaft for rotating the first reel, the second reel includes a second reel drive shaft for rotating the second reel, and wherein the first reel drive shaft is coupled to the second reel drive shaft via a universal joint.

7. The agricultural harvester header of claim 1, wherein the variable speed reel drive comprises:
a motor; and
a continuously variable transmission operatively connected to the motor and at least one of the first reel for rotatably driving the first reel and the second reel for rotatably driving the second reel.

8. The agricultural harvester header of claim 7, wherein the continuously variable transmission is operatively connected to the first and second reels for rotatably driving the first and second reels.

9. The agricultural harvester header of claim 7, wherein the continuously variable transmission is a push-belt continuously variable transmission, a variable-diameter pulley continuously variable transmission, a planetary continuously variable transmission, hydrostatic continuously variable transmission, or an infinitely variable transmission.

10. The agricultural harvester header of claim 7, wherein the continuously variable transmission includes a sheave mounted to one of a first reel drive shaft of the first reel and a second reel drive shaft of the second reel.

11. The agricultural harvester header of claim 1, wherein the variable speed reel drive comprises:
a motor; and
a planetary gear drive operatively coupled to the motor and at least one of the first and second reels.

12. The agricultural harvester header of claim 11, wherein the planetary gear drive is operatively coupled to the first and second reels.

13. The agricultural harvester header of claim 11, wherein the planetary gear drive comprises:
a ring gear;
at least one planetary gear within the ring gear; and
a sun gear within the ring gear.

14. The agricultural harvester header of claim 13, wherein the sun gear is operatively coupled to the first and second reels.

15. The agricultural harvester header of claim 13, wherein the sun gear is affixed to at least one of a first reel drive shaft of the first reel for rotating the first reel and a second reel drive shaft of the second reel for rotating the second reel.
